(19) United States
(12) Patent Application Publication
(10) Pub. No.: US 2006/0279583 A1
(43) Pub. Date: Dec. 14, 2006

(54) Information processing apparatus and image processing method

(76) Inventor: Eiki Obara, Hiki-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/450,069

(22) Filed: Jun. 9, 2006

(30) Foreign Application Priority Data
Jun. 13, 2005 (JP) 2005-172587

(51) Int. Cl. G09G 5/00

(52) U.S. Cl. 345/660

(57) ABSTRACT

According to one embodiment, an information processing apparatus includes an image processing unit which executes a non-linear scaling process of vertically dividing input image data having a first size into a plurality of image blocks and horizontally reducing at least one of the image blocks, which belongs to a central area of the input image data, and a display controller which enlarges the input image data, which is subjected to the non-linear scaling process, by linear scaling, generates output image data having a second size greater than the first size, and displays the generated output image data on a display device.

### CROSS-REFERENCE TO RELATED APPLICATIONS

This application is based upon and claims the benefit of priority from Japanese Patent Application No. 2005-172587, filed Jun. 13, 2005, the entire contents of which are incorporated herein by reference.

### BACKGROUND

1. Field

One embodiment of the invention relates to an information processing apparatus such as a personal computer, and an image processing method for use in the apparatus.

2. Description of the Related Art

In general, in a TV apparatus, a scaling technology is used in order to display image data with an aspect ratio of, e.g. 4:3, on a wide screen having an aspect ratio of 16:9. Non-linear scaling is known as an example of the scaling technology.

Jpn. Pat. Appln. KOKAI Publication No. 2000-148128 discloses an image enlargement process circuit which enlarges image data by non-linear scaling.

Using the non-linear scaling, it becomes possible to display image data on the entire wide screen without causing horizontal enlargement distortion of an image of a central area of the image data.

In general cases, an image of motion video, which is displayed on a central part of the screen, is important. Thus, the non-linear scaling is an effective technique for enlarging motion video.

In recent years, personal computers, which have the same AV reproducing functions as audio/video (AV) apparatuses such as DVD (Digital Versatile Disc) players and TV apparatuses, have been developed. The non-linear scaling is also suitable for displaying motion video on display devices of personal computers.

However, in general, a display controller, which is used in the information processing apparatus such as the personal computer, is provided with only a linear scaling function which uniformly enlarges image data with a fixed enlargement ratio. It is thus necessary to provide the personal computer with a dedicated circuit for non-linearly enlarging image data that is output from the display controller. The provision of such a dedicated circuit, however, is a large factor that leads to an increase in manufacturing cost of the personal computer.

Under the circumstances, there is a need to realize a novel function for displaying non-linearly enlarged image data on a display device without using a dedicated circuit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the external appearance of a computer according to an embodiment of the present invention;

FIG. 2 is an exemplary block diagram showing an example of the system configuration of the computer shown in FIG. 1;

FIG. 3 is an exemplary block diagram showing an example of the functional configuration of a TV application program which is used in the computer shown in FIG. 1;

FIG. 4 is an exemplary view for explaining an example of the flow of image data in the computer shown in FIG. 1;

FIG. 5 is an exemplary view for describing a first example of an image data enlargement process which is executed by the computer shown in FIG. 1;

FIG. 6 is an exemplary view for describing a second example of the image data enlargement process which is executed by the computer shown in FIG. 1;

FIG. 7 is an exemplary view for explaining an example of an enlargement ratio which is applied to each of image blocks in the image data enlargement process illustrated in FIG. 6;

FIG. 8 is an exemplary view for explaining an example of a pixel interpolation process for horizontally enlarging image blocks by using enlargement ratios, each of which is an integral multiple of 1/2ⁿ, in the computer shown in FIG. 1;

FIG. 9 is an exemplary view for explaining an example of a pixel interpolation process for horizontally reducing image blocks by using enlargement ratios, each of which is an integral multiple of 1/2ⁿ, in the computer shown in FIG. 1; and

FIG. 10 is an exemplary flow chart illustrating an example of the procedure of an image process which is executed by the computer shown in FIG. 1.

### DETAILED DESCRIPTION

Various embodiments according to the invention will be described hereinafter with reference to the accompanying drawings. In general, according to one embodiment of the invention, an information processing apparatus includes an image processing unit which executes a non-linear scaling process of vertically dividing input image data having a first size into a plurality of image blocks and horizontally reducing at least one of the image blocks, which belongs to a central area of the input image data, and a display controller which enlarges the input image data, which is subjected to the non-linear scaling process, by linear scaling, generates output image data having a second size greater than the first size, and displays the generated output image data on a display device.

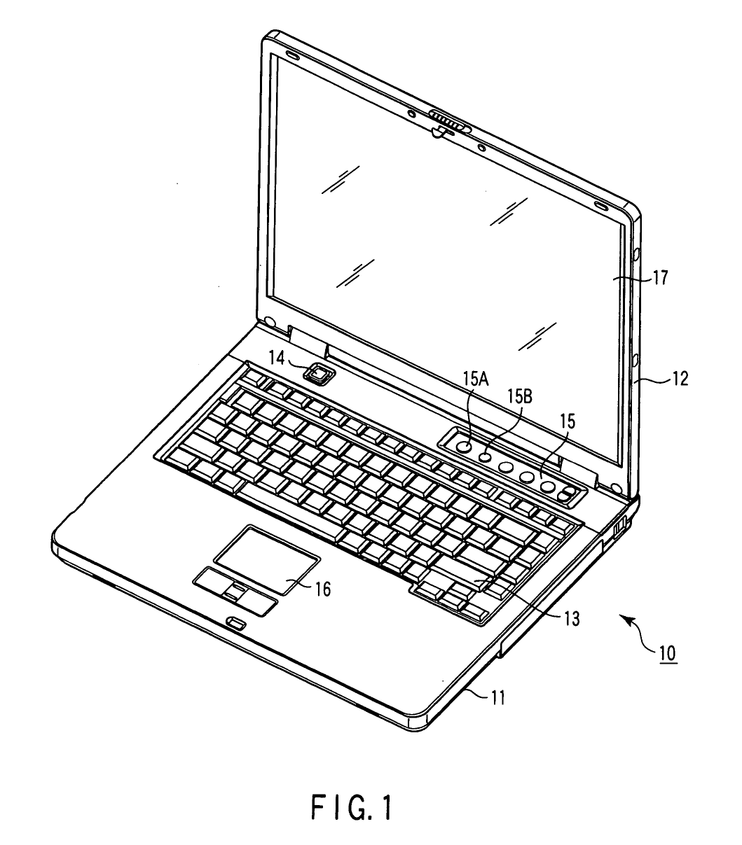

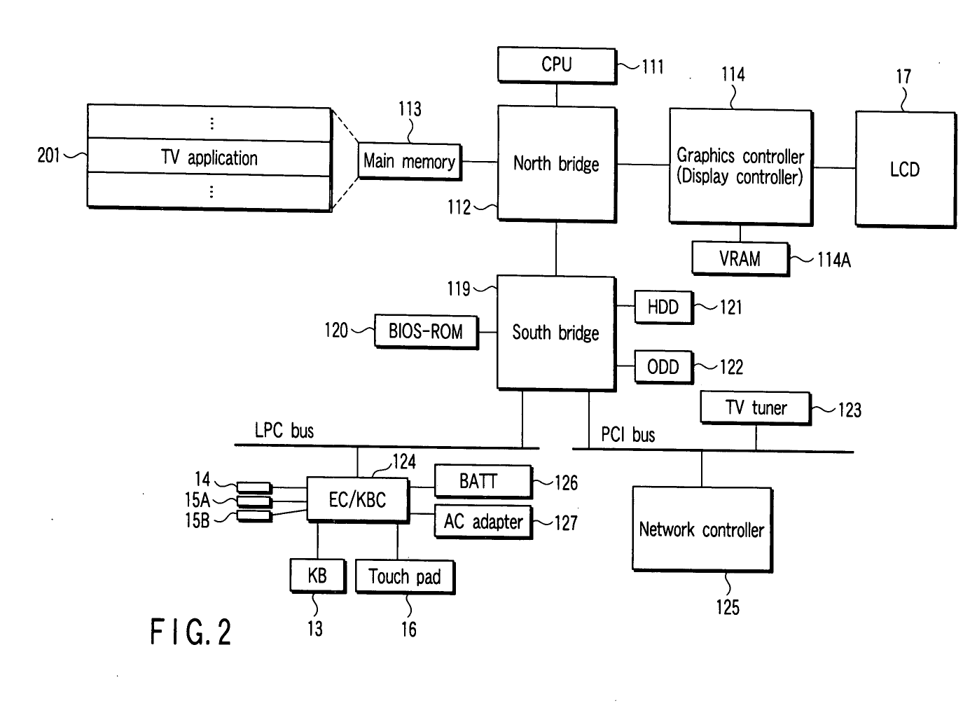

To begin with, referring to FIG. 1 and FIG. 2, the structure of an information processing apparatus according to an embodiment of the invention is described. The information processing apparatus is realized, for example, as a notebook portable personal computer 10.

FIG. 1 is a perspective view that shows the state in which a display unit of the personal computer 10 is opened. The computer 10 comprises a computer main body 11 and a display unit 12. A display device that is composed of a TFT-LCD (Thin Film Transistor Liquid Crystal Display) 17 is built in the display unit 12. The display screen of the LCD 17 is positioned at an approximately central part of the display unit 12. The LCD 17 has a horizontally elongated wide display screen. The size (resolution) of the display screen is, for example, 1440×900 pixels.

The display unit 12 is attached to the computer main body 11 such that the display unit 12 is freely rotatable between an open position and a closed position. The computer main body 11 has a thin box-shaped casing. A keyboard 13, a power button 14 for powering on/off the computer 10, an input operation panel 15 and a touch pad 16 are disposed on the top surface of the computer main body 11.

The input operation panel 15 is an input device that inputs an event corresponding to a pressed button. The input operation panel 15 has a plurality of buttons for activating a plurality of functions. The buttons include a TV activation button 15A and a DVD/CD activation button 15B. The TV activation button 15A is a button for activating a TV function for reproducing, viewing/listening to, and recording TV broadcast program data. When the TV activation button 15A is pressed by the user, a TV application program for executing the TV function is automatically started.

In this computer 10, a general-purpose main operating system and a purpose-specific sub-operating system for processing AV (audio/video) data are installed. The TV application program is a program that runs on the sub-operating system.

When the power button 14 is pressed by the user, the main operating system is booted up. On the other hand, when the TV activation button 15A is pressed by the user, the sub-operating system, and not the main operating system, is booted up, and the TV application program is automatically executed. The sub-operating system has only a minimum function for executing the AV function. The time that is needed to boot up the sub-operating system is much shorter than the time that is needed to boot up the main operating system. Thus, only by pressing the TV activation button 15A, the user can immediately execute TV viewing/recording.

The DVD/CD activation button 15B is a button for reproducing video content that is recorded on a DVD or a CD. When the DVD/CD activation button 15B is pressed by the user, a video reproduction application program for reproducing video content is automatically started. The video reproduction application program, too, is an application program that runs on the sub-operating system. When the DVD/CD activation button 15B is pressed by the user, the sub-operating system, and not the main operating system, is booted up, and the video reproduction application program is automatically executed.

Next, referring to FIG. 2, the system configuration of the computer 10 is described.

The computer 10, as shown in FIG. 2, comprises a CPU 111, a north bridge 112, a main memory 113, a graphics controller 114, a south bridge 119, a BIOS-ROM 120, a hard disk drive (HDD) 121, an optical disc drive (ODD) 122, a TV tuner 123, an embedded controller/keyboard controller IC (EC/KBC) 124, and a network controller 125.

The CPU 111 is a processor that is provided in order to control the operation of the computer 10. The CPU 111 executes the main operating system/sub-operating system and various application programs such as a TV application program 201, which are loaded from the hard disk drive (HDD) 121 into the main memory 113. The CPU 111 can execute a plurality of processes in parallel by using a plurality of pipelines.

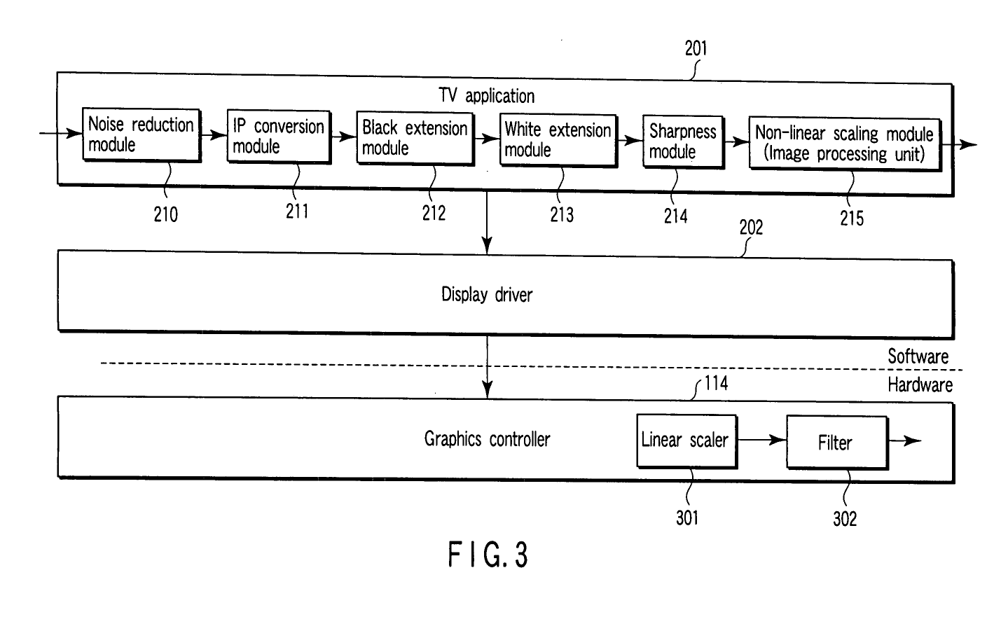

The TV application program 201 has a function of enhancing the image quality of image data (motion video data) included in TV broadcast program data that is received by the TV tuner 123. The size (resolution) of the image data included in the TV broadcast program data is, e.g. 720×480 pixels. As shown in FIG. 3, the TV application program 201 includes, as video processing functions for enhancing the image quality of image data, a noise reduction module 210, an IP (Interlace/Progressive) conversion module 211, a black extension module 212, a white extension module 213, a sharpness module 214 and a non-linear scaling module 215. The noise reduction module 210, IP (Interlace/Progressive) conversion module 211, black extension module 212, white extension module 213, sharpness module 214 and non-linear scaling module 215 are software modules.

The noise reduction module 210 executes a process for removing noise from image data which is included in broadcast program data that is received by the TV tuner 123. The IP conversion module 211 executes a progressive conversion process for converting image data from interlace video to progressive video which has double the data amount of the interlace video. The black extension module 212 and white extension module 213 execute processes for extension correction of black and white levels, respectively. The sharpness module 214 executes a sharpness process for, e.g. outline emphasis.

The non-linear scaling module 215 is an image process unit which executes a non-linear scaling process for generating image data in which an image of a central area is horizontally reduced. Specifically, the non-linear scaling module 215 executes the non-linear scaling process of vertically dividing image data of, e.g. 720×480 pixels into a plurality of image blocks, and horizontally reducing at least one of the divided image blocks, which belongs to the central area of the image data. In the non-linear scaling process, the non-linear scaling module 215 executes a process of horizontally altering the size of at least one of image blocks, which belongs to the central area, with an enlargement ratio that is less than 1, and a process of horizontally altering the sizes of the other image blocks with enlargement ratios that gradually increase toward the end portions of the image data.

Image data (720×480 pixels), which has been subjected to the non-linear scaling process by the non-linear scaling module 215, is written in the video memory 114A of the graphics controller 114 via a display driver 202. The display driver 202 is software for controlling the graphics controller 114.

A linear scaler 301 and a filter 302 are provided in the graphics controller 114. The linear scaler 301 uniformly enlarges image data, which has been subjected to the non-linear scaling process, with a fixed enlargement ratio by linear scaling, and generating output image data having a size (1440×900 pixels) corresponding to the size of the display screen of the LCD 17. The filter 302 is a filtering process unit which executes a filtering process for smoothing output image data that has been obtained by the linear scaling. The output image data, which has been subjected to the filtering process, is displayed on the LCD 17. The above-described process makes it possible to display image data, such as TV broadcast program data, on the entire wide screen of the LCD 17 with high image quality by a software process, without providing a dedicated circuit for executing a non-linear scaling process at the rear stage of the graphics controller 114.

The CPU 111 executes a system BIOS (Basic Input/Output System) that is stored in the BIOS-ROM 120. The system BIOS is a program for hardware control.

The north bridge 112 is a bridge device that connects a local bus of the CPU 111 and the south bridge 119. The north bridge 112 includes a memory controller that access-controls the main memory 113. The north bridge 112 has a function of executing communication with the graphics controller 114 via, e.g. an AGP (Accelerated Graphics Port) bus.

The graphics controller 114 is a display controller for controlling the LCD 17 that is used as a display monitor of the computer 10. The graphics controller 114 causes the LCD 17 to display image data, which is written in the video memory (VRAM) 114A. The graphics controller 114, as has been described with reference to FIG. 3, includes the linear scaler 301 and filter 302.

The south bridge 119 controls the devices on an LPC (Low Pin Count) bus, and the devices on a PCI (Peripheral Component Interconnect) bus. In addition, the south bridge 119 includes an IDE (Integrated Drive Electronics) controller for controlling the HDD 121 and ODD 122. The south bridge 119 also includes a function for access-controlling the BIOS-ROM 120.

The HDD 121 is a storage device that stores various software and data. The optical disc drive (ODD) 123 is a drive unit for driving storage media, such as a DVD or a CD, on which video content is stored. The TV tuner 123 is a receiving device for receiving broadcast program data such as TV broadcast program data. The TV tuner 123 includes an encoder for compression-encoding broadcast program data. When a recording process is executed to store received broadcast program data in the HDD 121, the received broadcast program data is compression-encoded by the encoder, and the compression-encoded broadcast program data is transferred to the main memory 113 via the PCI bus, south bridge 119 and north bridge 112. On the other hand, when received broadcast program data is displayed on the LCD 17, the received broadcast program data is not compression-encoded and is transferred to the main memory 113 via the PCI bus, south bridge 119 and north bridge 112.

The embedded controller/keyboard controller IC (EC/KBC) 124 is a 1-chip microcomputer in which an embedded controller for power management and a keyboard controller for controlling the keyboard (KB) 13 and touch pad 16 are integrated. The embedded controller/keyboard controller IC (EC/KBC) 124 has a function of powering on/off the computer 10 in response to the user's operation of the power button 14. Operation power, which is supplied to the respective components of the computer 10, is generated from a battery 126 which is built in the computer 10 or from an external power supply which is supplied via an AC adapter 127.

Further, the embedded controller/keyboard controller IC (EC/KBC) 124 is capable of powering on/off the computer 10 in response to the user's operation of the TV activation button 15A or DVD/CD activation button 15B. The network controller 125 is a communication device that executes communication with an external network such as the Internet.

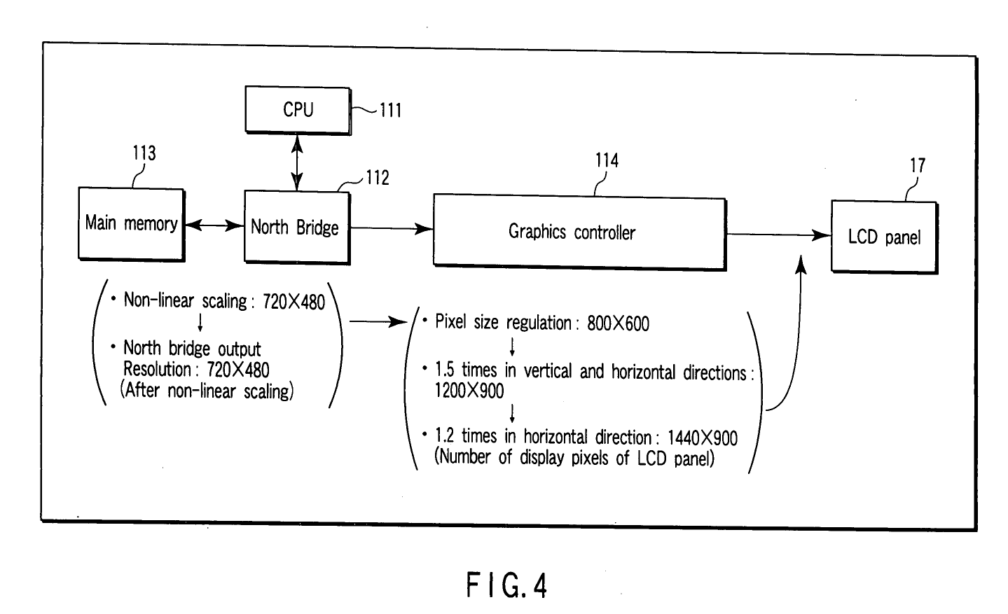

Next, referring to FIG. 4, the flow of image data in the case of executing non-linear scaling by a software process is described.

In the case where an image process is executed by software, if the load on the CPU 111 by the image process exceeds a predetermined level, other functions that are executed by the CPU 111 would be affected or real-time processing of image data would be disabled. Thus, when an image process is executed by software, it is very important to reduce the load on the CPU 111. In the present embodiment, in order to realize a size altering process (enlargement/reduction) of image data, which is necessary for a non-linear scaling process, by an arithmetic process with a relatively light load, the size altering process is executed with enlargement ratios each corresponding to an integer number of times of 1/(a power of 2), i.e. an integral multiple of 1/2ⁿ (n is an integer). Thereby, a pixel interpolation process for altering the size of an image in the horizontal direction can be realized by only an arithmetic process including bit shift and multiplication of integers, and the load on the CPU 111, which is necessary for the size altering process, can greatly be reduced.

By the non-linear scaling process which is executed by the CPU 111 on the main memory 113, a central part of image data with a resolution (number of pixels) of 720×480 is reduced in the horizontal direction, while the total number of pixels is unchanged in the horizontal and vertical directions. Further, the image data is horizontally altered in size with enlargement ratios that increase toward both ends of the image data. The image data (720×480 pixels), which is obtained by the non-linear scaling process, is transferred from the main memory 113 to the graphics controller 114 via the north bridge 112.

In the graphics controller 114, the image data (720×480 pixels), which is transferred from the north bridge 112 to the graphics controller 114, is subjected to pixel size regulation (i.e. a process for altering the pixel size to 800×600 pixels) and, at last, is linearly enlarged to image data of 1440×900 pixels. The enlarged image data is sent to the LCD 17. As a result, the image data, which is sent to the LCD 17, is a so-called non-linearly scaled image, which is obtained by horizontally enlarging the original image with enlargement ratios that gradually increase from a central area toward both ends of the image data. By the above process, image data with an aspect ratio of, e.g. 4:3 can be displayed on the entire wide screen of the LCD 17, which has an aspect ratio of, e.g. 16:9 or 16:10, without causing horizontal enlargement distortion of an image at the central area of the screen.

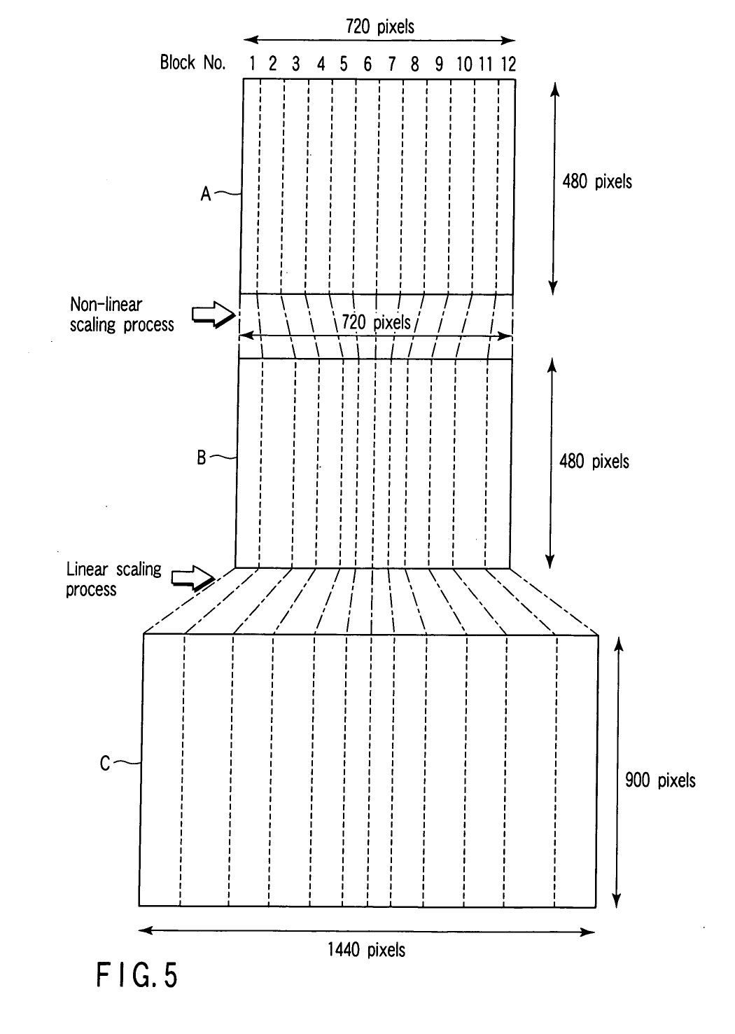

Next, referring to FIG. 5, a first example of the image data enlarging process, which is executed in the present embodiment, is described.

(1) Non-linear Scaling Process by Software

The size of original image data (A) with 720×480 pixels is altered such that a central area of the original image data (A) is horizontally reduced while the size of the original image data (A) is horizontally altered with enlargement ratios that gradually increase toward both ends of the image data, with the total number of pixels being unchanged in the horizontal and vertical directions. Thereby, image data (B) is obtained.

The non-linear scaling module 215 vertically divides original image data (A) with, e.g. 720×480 pixels into, e.g. 12 image blocks. The non-linear scaling module 215 horizontally reduces image blocks 6 and 7 which belong to the central area. Further, the non-linear scaling module 215 horizontally alters the sizes of the other image blocks with enlargement ratios that gradually increase toward both ends of the image data.

In this case, the enlargement ratio corresponding to each of the image blocks is set to be an integer number of times of 1/(a power of 2), that is, m/2ⁿ, where m and n are integers. Thereby, the arithmetic process for enlarging/reducing the image blocks can be executed by only bit shift and multiplication of integers.

In normal cases, image data that is non-linearly scaled needs to be subjected to a filtering process for smoothing. In the present embodiment, however, the non-linear scaling process is followed by the linear scaling process and filtering process in the graphics controller 114. Thus, the execution of a filtering process by a software process is omitted. The omission of the filtering process can further reduce the load on the CPU 111.

(2) Linear Scaling Process by Graphics Controller

In the graphics controller 114, for example, image data (B) is enlarged 1.5 times in the horizontal direction and vertical direction by the linear scaling process, and the image data (B) is further enlarged 1.2 times in the horizontal direction by the linear scaling process. Thereby, image data (C) of 1440×900 pixels, which is equal in size to the display screen of the LCD 17, is generated.

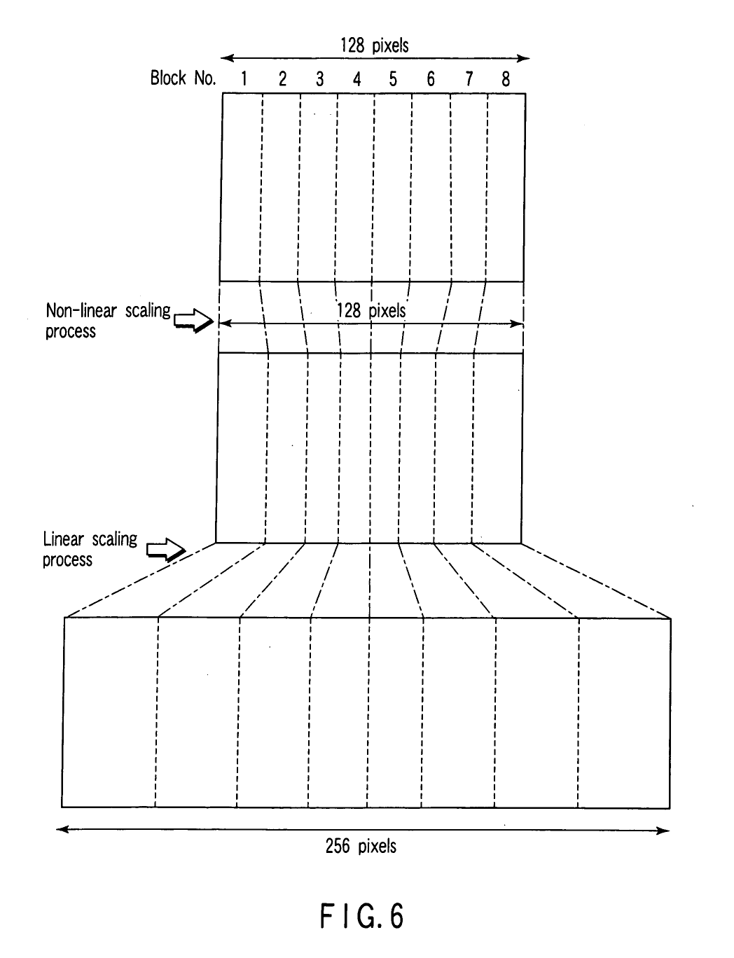

Next, referring to FIG. 6, a second example of the image data enlarging process, which is executed in the present embodiment, is described.

It is assumed that original image data is enlarged two times in the horizontal direction.

(1) Non-linear Scaling Process by Software

The total number of pixels of original image data (A) in the horizontal direction is 128. A central area of the original image data (A) is horizontally reduced without altering the total number of pixels in the horizontal and vertical directions, and the image data (A) is horizontally altered in size with enlargement ratios that gradually increase toward both ends. Thus, image data (B) is obtained.

The non-linear scaling module 215 vertically divides the original image data (A) into, for example, eight image blocks. The non-linear scaling module 215 horizontally reduces image blocks 3, 4, 5 and 6 which belong to the central area. Further, the non-linear scaling module 215 horizontally alters (enlarges) the sizes of the other image blocks with enlargement ratios that gradually increase toward the blocks located at both ends of the image data.

(2) Linear Scaling Process by Graphics Controller

In the graphics controller 114, for example, the image data (B) is horizontally enlarged two times by the linear scaling process.

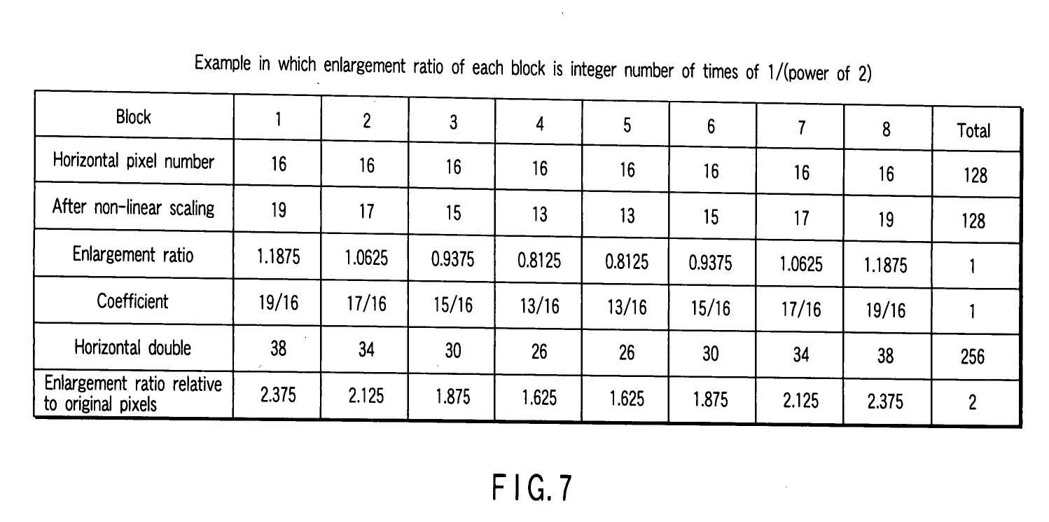

Referring now to FIG. 7, the enlargement ratios which are applied to the respective image blocks shown in FIG. 6 are explained.

An item “Horizontal Pixel Number” in FIG. 7 corresponds to the number of horizontal pixels of each of the blocks 1 to 8 of the original image data (A) shown in FIG. 6. An item “After Non-Linear Scaling” in FIG. 7 corresponds to the number of horizontal pixels of each of the blocks 1 to 8 of the image data (B) shown in FIG. 6. An item “Enlargement Ratio” in FIG. 7 indicates the value of the enlargement ratio which is applied to each of the blocks 1 to 8 of the original data (A). An item “Coefficient” in FIG. 7 expresses the enlargement ratio by a fraction. As is clear from the value of “Coefficient” in FIG. 7, the denominator of each of the coefficients is a power of 2. Thus, the enlargement ratio of each image block is an integral multiple of 1/2ⁿ. The enlargement ratio of each of the central blocks 4 and 5 is 0.8125 (= 13/16). The enlargement ratio of each of the blocks 3, 2 and 1, which are positioned on the left side of the central blocks 4 and 5, is greater than the enlargement ratio of each of the central blocks 4 and 5, and the enlargement ratios of the blocks 3, 2 and 1 increase in the named order. The enlargement ratio of each of the blocks 6, 7 and 8, which are positioned on the right side of the central blocks 4 and 5, is greater than the enlargement ratio of each of the central blocks 4 and 5, and the enlargement ratios of the blocks 6, 7 and 8 increase in the named order. An item “Horizontal Double” in FIG. 7 indicates the number of horizontal pixels of each of the blocks 1 to 8 after the number of horizontal pixels of each of the blocks 1 to 8 is increased two times in the horizontal direction by the linear scaling.

Next, a description is given of a pixel interpolation process which is executed by the non-linear scaling module 215 in order to alter (enlarge or reduce) the sizes of the image blocks with enlargement ratios each corresponding to an integral multiple of 1/2ⁿ.

As described above, by using the enlargement ratios each corresponding to an integral multiple of 1/2ⁿ, the arithmetic operation for executing the pixel interpolation process can greatly be simplified.

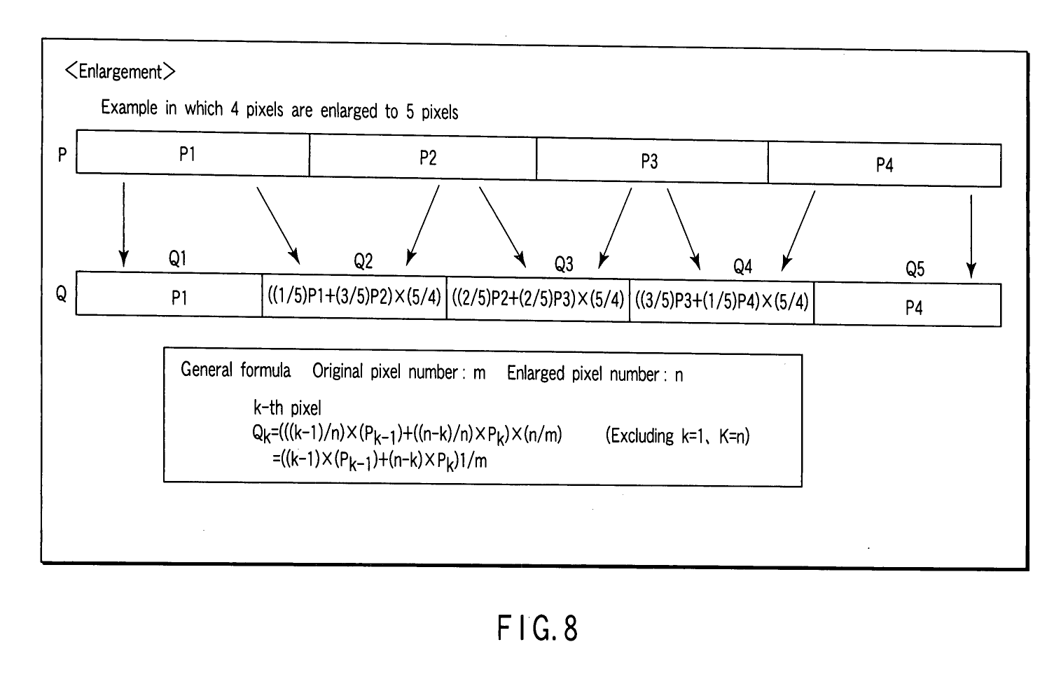

FIG. 8 shows an example of the pixel interpolation process in the case where the image block is horizontally enlarged with enlargement ratios each corresponding to an integral multiple of 1/2ⁿ.

For the purpose of simple description, assume the case in which the number of horizontal pixels of the image block is increased from four to five by the interpolation process (enlargement ratio=5/4). An original image block P is composed of four pixels P1 to P4. An enlarged image block Q is composed of five pixels Q1 to Q5.

The pixel value of the pixel Q1 is equal to that of the pixel P1. The pixel value of the pixel Q2 is generated from the pixel values of two pixels P1 and P2. The pixel value of the pixel Q3 is generated from the pixel values of two pixels P2 and P3. The pixel value of the pixel Q4 is generated from the pixel values of two pixels P3 and P4. The pixel value of the pixel Q5 is equal to that of the pixel P4.

A general formula of the pixel interpolation process in the case of enlargement is given by
Qₖ=(((k−1)/n)×(Pₖ₋₁)+((n−k)/n)×Pₖ)×(n/m)
(excluding

$$\begin{matrix}k = 1 and k \\ = n ) \\ = ( ( k - 1 ) \times ( {P}_{k - 1} ) + ( ( n - k ) \times {P}_{k} ) 1 / m\end{matrix} \qquad ( 1 )$$

where m is the number of horizontal pixels of original image block P, n is the number of horizontal pixels of the enlarged image block Q, and Qₖ is the pixel value of a k-th pixel within the enlarged image block Q.

As is clear from the formula (1), the value that appears in the denominator can be limited to m. Accordingly, by setting the enlargement ratio (n/m) at an integral multiple of 1/(a power of 2), the division of “1/m” can easily be executed by only bit shift.

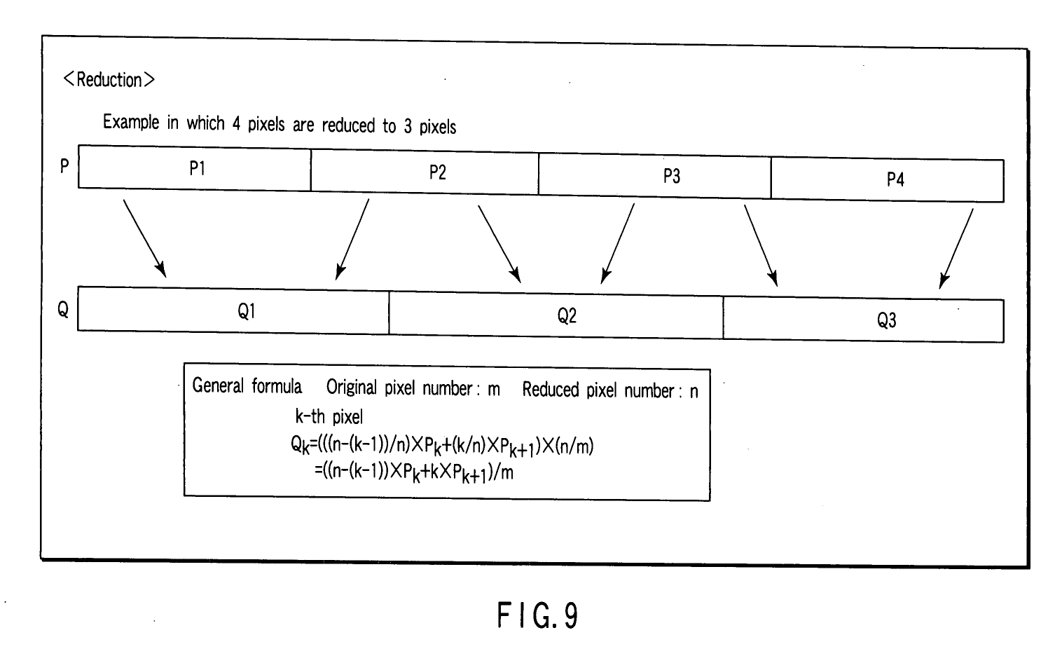

FIG. 9 shows an example of the pixel interpolation process in the case where the image block is horizontally reduced with enlargement ratios each corresponding to an integral multiple of 1/2ⁿ.

For the purpose of simple description, assume the case in which the number of horizontal pixels of the image block is decreased from four to three by the interpolation process (enlargement ratio=3/4). An original image block P is composed of four pixels P1 to P4. A reduced image block Q is composed of three pixels Q1 to Q3.

The pixel value of the pixel Q1 is generated from the pixel values of two pixels P1 and P2. The pixel value of the pixel Q2 is generated from the pixel values of two pixels P2 and P3. The pixel value of the pixel Q3 is generated from the pixel values of two pixels P3 and P4.

A general formula of the pixel interpolation process in the case of reduction is given by
Qk=(((n−(k−1))/n)×Pₖ+(k/n)×Pₖ₊₁)×(n/m)=((n−(k−1))×Pₖ+k×Pₖ₊₁)/m (2)

where m is the number of horizontal pixels of original image block P, n is the number of horizontal pixels of the reduced image block Q, and Qₖ is the pixel value of a k-th pixel within the reduced image block Q.

As is clear from the formula (2), the value that appears in the denominator can also be limited to m in the arithmetic operation of the pixel interpolation process for reduction. Accordingly, by setting the enlargement ratio (n/m) at an integral multiple of 1/2ⁿ, the division of “1/m” can easily be executed by only bit shift.

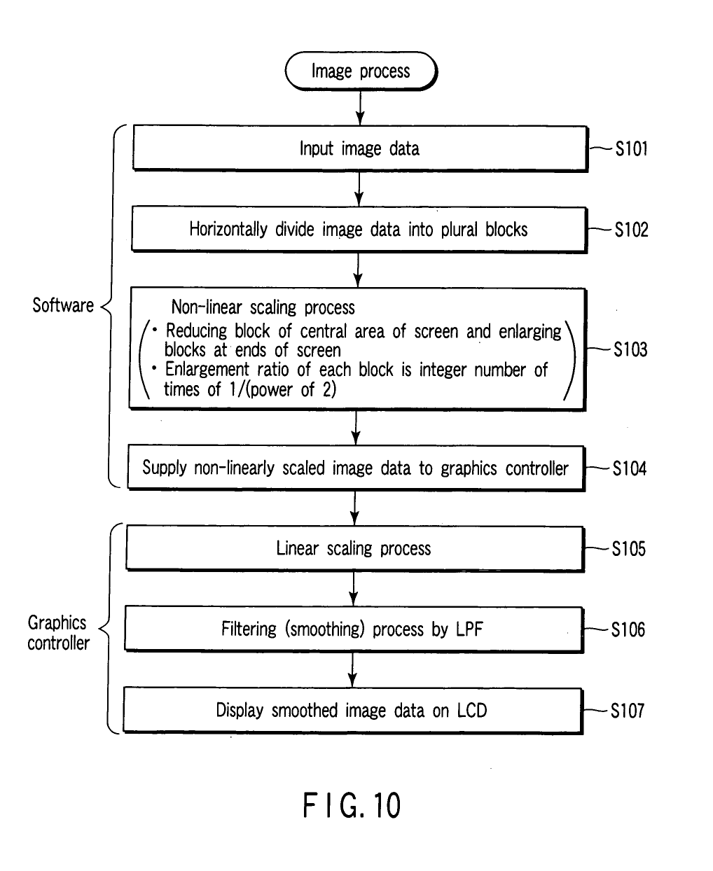

Next, referring to a flow chart of FIG. 10, the procedure of the image process which is executed in the present embodiment is described.

To start with, the CPU 111, that is, the non-linear scaling module 215, inputs image data which is to be processed (block S101). The CPU 111, or the non-linear scaling module 215, divides input image data into a plurality of vertically extending image blocks (block S102), and subjects the input image data to a non-linear scaling process (block S103). In block S103, the CPU 111, or the non-linear scaling module 215, horizontally alters the size of at least one image block, which belongs to a central area of the input image data, with an enlargement ratio less than 1, thereby horizontally reducing the at least one image block. Further, in block S103, the CPU 111, or the non-linear scaling module 215, horizontally alters the sizes of the other image blocks with enlargement ratios which have values greater than the enlargement ratio corresponding to the image block of the central block and gradually increase toward end portions of the input image data. As regards any one of the image blocks of the input image data, a value corresponding to an integral multiple of 1/2ⁿ is chosen as the enlargement ratio. In the size altering process, the CPU 111, or the non-linear scaling module 215, executes an arithmetic process including multiplication of positive integers and bit shift.

Subsequently, the CPU 111, or the non-linear scaling module 215, sends the non-linearly scaled image data to the graphics controller 114 (block S104).

The graphics controller 114 horizontally enlarges the non-linearly scaled image data by linear scaling with a fixed horizontal enlargement ratio (or horizontally and vertically enlarges the non-linearly scaled image data by linear scaling with a fixed horizontal enlargement ratio and a fixed vertical enlargement ratio), thereby generating output image data of a size corresponding to the screen size of the LCD 17 (block S105). Then, the graphics controller 114 executes a filtering process for smoothing the output image data by a filter circuit (LPF: Low-Pass Filter) 302 (block S106). The graphics controller 114 displays the smoothed output image data on the LCD 17 (block S107).

As has been described above, according to the present embodiment, the central area of the image data is once horizontally reduced by the software process, and the reduced image data is uniformly enlarged by the graphics controller 114 and displayed on the wide screen of the LCD 17. Thus, the non-linear scaling function can be realized by using an existing graphics controller, without providing a dedicated non-linear scaler circuit at a rear stage of the graphics controller 114. Therefore, the manufacturing cost can be reduced, compared to the case of providing a dedicated non-linear scaler circuit.

In the non-linear scaling process of the present embodiment, the enlargement ratio of each image block is an integral multiple of 1/2ⁿ. Hence, the pixel interpolation process for enlargement/reduction is realized by multiplication of integers and bit shift, and there is no need to execute a floating point arithmetic operation with a heavy load. Therefore, the non-linear scaling process can be executed by software without causing an increase of the load on the CPU 111.

In the graphics controller 114, the filter 302 is present at the rear stage of the linear scaler 301. Therefore, the execution of a filtering process after the non-linear scaling can advantageously be omitted.

In the non-linear scaling process by the software, it is possible to execute only the process of horizontally reducing the central area of the image data. In this case, too, it is possible to prevent horizontal enlargement distortion of a central area of the enlarged image.

The present embodiment is directed, by way of example, to the case in which image data, which is included in broadcast program data, is enlarged and displayed. The image processing method of this embodiment, however, is also applicable to the case in which image data or the like, which is read out of a storage medium such as a DVD, is enlarged and displayed. Furthermore, the non-linear scaling module 215 may be realized by hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an image processing unit which executes a non-linear scaling process of vertically dividing input image data having a first size into a plurality of image blocks and horizontally reducing at least one of the image blocks, which belongs to a central area of the input image data; and
a display controller which enlarges the input image data, which is subjected to the non-linear scaling process, by linear scaling, generates output image data having a second size greater than the first size, and displays the generated output image data on a display device.

2. The information processing apparatus according to claim 1, wherein the non-linear scaling process includes a process of horizontally altering a size of the at least one of the image blocks, which belongs to the central area, with an enlargement ratio which is less than 1, and a process of horizontally altering sizes of the other image blocks with enlargement ratios which increase toward ends of the input image data.

3. The information processing apparatus according to claim 1, wherein the non-linear scaling process includes a process of horizontally altering a size of the at least one of the image blocks, which belongs to the central area, with an enlargement ratio which is an integral multiple of 1/2ⁿ and is less than 1, n being an integer.

4. The information processing apparatus according to claim 1, wherein the non-linear scaling process includes a process of horizontally altering sizes of the plurality of image blocks with a plurality of enlargement ratios having values, each of which is an integral multiple of 1/2ⁿ, n being an integer.

5. The information processing apparatus according to claim 1, wherein the non-linear scaling process includes a pixel interpolation process for horizontally altering sizes of the plurality of image blocks with a plurality of enlargement ratios having values, each of which is an integral multiple of 1/2ⁿ, the n is an integer, and the image processing unit executes the pixel interpolation process by an arithmetic process including bit shift and multiplication of integers.

6. The information processing apparatus according to claim 1, wherein the display controller includes a filtering process unit which executes a filtering process of smoothing the generated output image data, and the output image data, which is subjected to the filtering process, is displayed on the display device.

7. The information processing apparatus according to claim 1, further comprising a receiving device which receives broadcast program data, wherein the input image data is the broadcast program data which is received by the receiving device.

8. An image processing method which processes image data using a display controller having a linear scaling function, comprising:
executing a non-linear scaling process of vertically dividing input image data having a first size into a plurality of image blocks and horizontally reducing at least one of the image blocks, which belongs to a central area of the input image data; and
sending the input image data, which is subjected to the non-linear scaling process, to the display controller, and causing the display controller to execute a process of enlarging the input image data, which is subjected to the non-linear scaling process, by linear scaling and generating output image data having a second size greater than the first size; and
displaying the generated output image data on a display device.

9. The image processing method according to claim 8, wherein the non-linear scaling process includes a process of horizontally altering a size of the at least one of the image blocks, which belongs to the central area, with an enlargement ratio which is less than 1, and a process of horizontally altering sizes of the other image blocks with enlargement ratios which increase toward ends of the input image data.

10. The image processing method according to claim 8, wherein the non-linear scaling process includes a process of horizontally altering a size of the at least one of the image blocks, which belongs to the central area, with an enlargement ratio which is an integral multiple of 1/2ⁿ and is less than 1, n being an integer.

11. The image processing method according to claim 8, wherein the non-linear scaling process includes a process of horizontally altering sizes of the plurality of image blocks with a plurality of enlargement ratios having values, each of which is an integral multiple of 1/2ⁿ, n being an integer.

12. The image processing method according to claim 8, wherein the non-linear scaling process includes a pixel interpolation process for horizontally altering sizes of the plurality of image blocks with a plurality of enlargement ratios having values, each of which is an integral multiple of 1/2ⁿ, n being is an integer, and said executing the non-linear scaling process includes executing the pixel interpolation process by an arithmetic process including bit shift and multiplication of integers.
